(19) United States
(12) Patent Application Publication
(10) Pub. No.: US 2008/0237360 A1
(43) Pub. Date: Oct. 2, 2008

(54) POS SYSTEM AND METHOD OF CONTROLLING POS SYSTEM

(75) Inventors: Toki HOKAZONO, Inagi (JP); Takashi TOYOKAWA, Inagi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignees: FUJITSU LIMITED, Kawasaki-shi (JP); FUJITSU FRONTECH LIMITED, Tokyo (JP)

(21) Appl. No.: 12/056,698

(22) Filed: Mar. 27, 2008

(30) Foreign Application Priority Data
Mar. 28, 2007 (JP) 2007-085788

(51) Int. Cl. G07G 1/00

(52) U.S. Cl. 235/7 A

(57) ABSTRACT

A receipt-and-payment-information transmitting unit of a change dispenser transmits receipt and payment information of receipt and payment processing, which is started according to reception of a start instruction for independent operation, to a POS terminal. An icon display/deleting unit of the POS terminal causes a display device to display an icon indicating that receipt and payment information is received on a display screen. An alternation-processing prohibiting/releasing unit prohibits execution of operator alternation processing. A receipt-and-payment-information registering unit registers, in a storing unit, receipt and payment information including a receipt and payment type input from a receipt-and-payment-type input screen displayed according to an execution instruction for the icon. When receipt and payment types corresponding to all pieces of receipt and payment information are registered, the icon display/deleting unit deletes the icon from the display screen. The alternation-processing prohibiting/releasing unit 23 releases the prohibition of execution of the operator alternation processing.

### BACKGROUND OF THE INVENTION

1. Field of the Invention

The present invention relates to a point-of-sale (POS) system including a POS terminal and a change dispenser and a method of controlling the POS system.

2. Description of the Related Art

A POS system is widely used as a system that settles accounts for commodities purchased by customers and manages reception and payment information. As such a POS system, there is also a POS system in which a change dispenser is connected to a POS terminal. Japanese Patent Application Laid-open No. 2002-117456 discloses a technology concerning the POS system in which the change dispenser is connected to the POS terminal. In this POS system, the POS terminal generates receipt and payment processing data in advance and the change dispenser acquires the processing data from the POS terminal and performs processing for receipt and payment according to processing classification included in the processing data.

The change dispenser is an apparatus that can be caused to operate independently. Therefore, the change dispenser has a function of managing content of the receipt and payment processing performed by the change dispenser. However, in the POS system, information not managed by the change dispenser, for example, types of the receipt and payment processing is also managed. Therefore, in the POS system in which the change dispenser is connected to the POS terminal, to unitarily manage receipt and payment information, an operator does not cause the change dispenser to transmit the content of the receipt and payment processing performed by the change dispenser to the POS terminal. Instead, the operator inputs receipt and payment information including the types of the receipt and payment processing in the POS terminal in advance, transmits an instruction for starting the receipt and payment processing to the change dispenser, and, then, causes the change dispenser to perform the receipt and payment processing. Consequently, consistency of receipt and payment information managed by both the POS terminal and the change dispenser is realized.

However, when the operator inputs the receipt and payment information in the POS terminal in advance and, then, causes the change dispenser to execute the receipt and payment processing, for example, if change stored in the change dispenser is out of the stock, it takes a lot of labor and time for the operator to perform the receipt and payment processing. As a result, for example, in a mass merchandiser where quick settlement of accounts is required, the receipt and payment processing causes customers to wait. Therefore, giving priority to quickness, in some case, the operator causes the change dispenser to operate independently without receiving the start instruction from the POS terminal and perform the receipt and payment processing. In this case, for example, work for inputting the receipt and payment information including the types of the receipt and payment processing performed by the POS terminal in advance does not have to be performed. Therefore, it is possible to reduce time required for the receipt and payment processing.

However, when the operator causes the change dispenser to operate independently without receiving the start instruction from the POS terminal and perform the receipt and payment processing, the types of the receipt and payment processing are not managed by the change dispenser. The receipt and payment information including the types of the receipt and payment processing cannot be transmitted to the POS terminal. Therefore, consistency of the receipt and payment information managed by both the POS terminal and the change dispenser cannot be realized. Consequently, it cannot be specified later what the receipt and payment processing is performed for and wrong calculation is performed.

### SUMMARY OF THE INVENTION

It is an object of the present invention to at least partially solve the problems in the conventional technology.

According to an aspect of the present invention, a POS system includes a POS terminal and a change dispenser, wherein the change dispenser includes a start-instruction receiving unit that receives an independent operation start instruction for causing the change dispenser to start receipt and payment operation independently; and a receipt-and-payment-information transmitting unit that transmits, when the independent operation start instruction is received by the start-instruction receiving unit, receipt and payment information including a receipt and payment amount received and paid after the independent operation start instruction to the POS terminal, wherein the POS terminal includes a receipt-and-payment-information receiving unit that receives the receipt and payment information transmitted from the change dispenser; an indicator display unit that causes, when the receipt and payment information is received by the receipt-and-payment-information receiving unit, a display device to display an indicator indicating that the receipt and payment information is received on a display screen; an execution-instruction detecting unit that detects an execution instruction for the indicator displayed by the indicator display unit; an input-screen display unit that displays, when the execution instruction is detected by the execution-instruction detecting unit, an input screen for enabling an operator to input a receipt and payment type for each receipt and payment amount included in the receipt and payment information on the display screen; a registering unit that registers the receipt and payment type input from the input screen, which is displayed by the input-screen display unit, in association with the receipt and payment information including the receipt and payment amount in a storing unit; and an indicator deleting unit that deletes the indicator from the display screen when receipt and payment types corresponding to receipt and payment amounts included in all pieces of receipt and payment information received by the receipt-and-payment-information receiving unit are registered.

According to another aspect of the present invention, method of controlling a POS system including a POS terminal and a change dispenser includes receiving an independent operation start instruction for causing the change dispenser to start receipt and payment operation independently in the change dispenser; transmitting, when the independent operation start instruction is received in the change dispenser, receipt and payment information including a receipt and payment amount received and paid after the independent operation start instruction from the change dispenser to the POS terminal; receiving the receipt and payment information transmitted from the change dispenser in the POS terminal; displaying, when the receipt and payment information is received in the POS terminal, an indicator indicating that the receipt and payment information is received on a display screen of the POS terminal; detecting an execution instruction for the indicator; displaying, when the execution instruction is detected in the POS terminal, an input screen for enabling an operator to input a receipt and payment type for each receipt and payment amount included in the receipt and payment information on the display screen; registering the receipt and payment type input from the input screen in association with the receipt and payment information including the receipt and payment amount in a storing unit; and deleting the indicator from the display screen when receipt and payment types corresponding to receipt and payment amounts included in all pieces of receipt and payment information are registered.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram of a configuration of a POS system according to an embodiment of the present invention;

FIG. 2 is an external perspective view of a change dispenser according to the embodiment;

FIG. 3 is a diagram of an upper inner section of the change dispenser according to the embodiment;

FIG. 4 is a diagram of an example of the screen structure of a receipt-and-payment-type input screen according to the embodiment;

FIG. 5 is a diagram of an example of the data structure of receipt and payment information according to the embodiment;

FIG. 6 is a flowchart of a processing procedure of a change dispenser according to the embodiment; and

FIG. 7 is a flowchart of a processing procedure of a POS terminal according to the embodiment.

### DETAILED DESCRIPTION OF THE PREFERRED EMBODIMENTS

Exemplary embodiments of the present invention are explained in detail below with reference to the accompanying drawings.

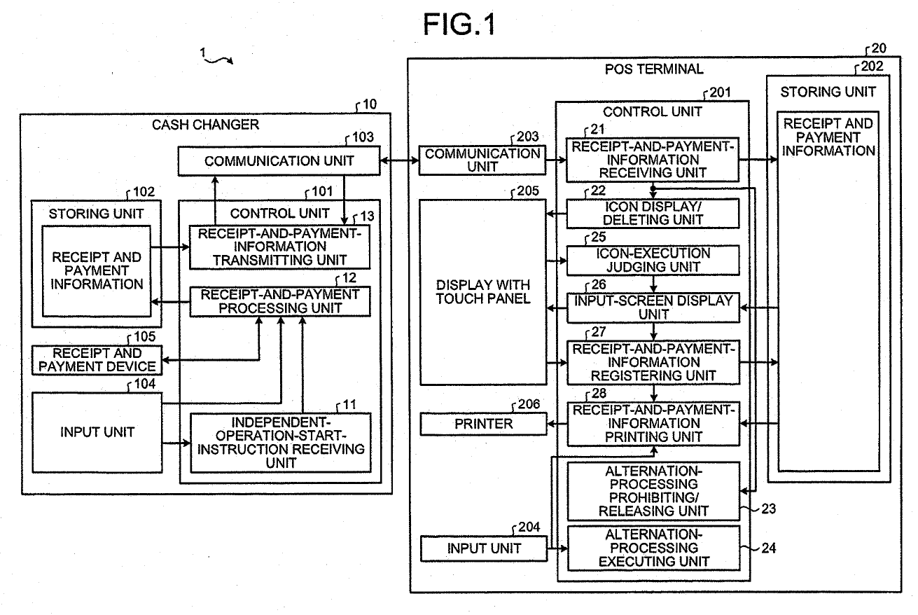

FIG. 1 is a diagram of a configuration of a POS system according to an embodiment of the present invention. As shown in the figure, a POS system 1 includes a change dispenser 10 and a POS terminal 20.

The change dispenser 10 is an apparatus that can operate in association with the POS terminal 20. Specifically, for example, when sales processing for commodities is performed by the POS terminal 20 and bills or coins are input from an input port of the change dispenser 10, the change dispenser 10 discharges change obtained by subtracting a sales amount from the input amount from a payment port. On the other hand, the POS terminal 20 is an apparatus that performs sales processing for commodities purchased by a customer and manages receipt and payment information and the like.

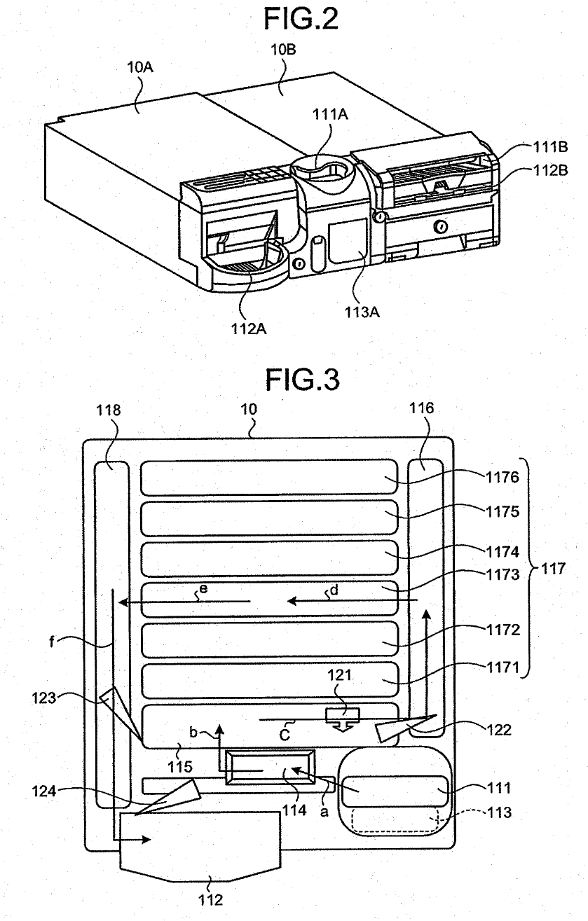

FIG. 2 is an external perspective view of the change dispenser 10. The change dispenser 10 shown in the figure includes a coin changer 10A and a bill changer 10B. The coin changer 10A is an apparatus that receives a coin input from an input port 111A and discharges a coin from a discharge port 112A or a return port 113A. The bill changer 10B is an apparatus that receives a bill input from an input port 111B and discharges a bill from a discharge port 112B also serving as a return port. The coin changer 10A and the bill changer 10B functionally have the same structure. Therefore, in this embodiment, to simplify explanation, the coin changer 10A is used as the change dispenser 10. However, this does not mean that a change dispenser applicable to the present invention is limited to the coin changer 10A. In other words, the change dispenser applicable to the present invention can be a change dispenser including the coin changer 10A and the bill changer 10B or can be any one of the coin changer 10A and the bill changer 10B.

FIG. 3 is a diagram of an upper inner section of the change dispenser 10. As shown in the figure, the change dispenser 10 includes an input port 111, a storing device 117, a discharge port 112, a received-money conveying path (a path “a”, a path “b”, a path “c”, and a path “d”) formed between the input port 111 and the storing device 117, and a payment-money conveying path (a path “e” and a path “f”) formed between the storing device 117 and the discharge port 112. The storing device 117 includes a 1-yen coin store 1171, a 50-yen coin store 1172, a 5-yen coin store 1173, a 100-yen coin store 1174, a 10-yen coin store 1175, and a 500-yen coin store 1176. The received-money conveying path includes a coin inspecting unit 114 that identifies denominations of received coins and totals a received amount and a temporary holding unit 115 that temporarily holds the coins. The payment-money conveying path includes a payment unit 118 that causes the storing device 117 to pay coins.

In such a change dispenser 10, for example, when the 5-yen coin is input from the input port 111, the 5-yen coin is conveyed to the coin inspecting unit 114 through the path “a”. The coin inspecting unit 114 identifies that a denomination is 5 yen. After a received amount is totaled, the 5-yen coin is conveyed to the temporary holding unit 115 through the path “b”. Thereafter, the 5-yen coin conveyed from the temporary holding unit 115 is stored in the 5-yen coin store 1173 through the path “c” and the path “d” switched by a storage switching gate 122. On the other hand, for example, when the 5-yen coin is paid, the 5-yen coin paid from the 5-yen coin store 1173 by the payment unit 118 through the path “e” is discharged to the discharge port 112 through the path “f” switched by a payment switching gate 123.

In a change dispenser, because the identification of a denomination, the totaling of an amount, and the like are performed during receipt and payment processing, the receipt and payment processing takes time and it is difficult to reduce the time. On the other hand, when the operator causes the change dispenser to operate independently and perform the receipt and payment processing without receiving a start instruction from a POS terminal, it is possible to omit, for example, prior input of receipt and payment information in the POS terminal. Therefore, it is possible to reduce the time required for the receipt and payment processing. Therefore, in this embodiment, when the operator causes the change dispenser 10 to operate independently and perform the receipt and payment processing, the operator causes the change dispenser 10 to notify the POS terminal 20 of content of the receipt and payment processing and the POS terminal 20 receives the notification. The POS terminal 20 can additionally input a type of the receipt and payment processing by causing a display device to display an icon on a screen and enabling the operator to execute the icon. Consequently, in the receipt and payment processing, when there are customers waiting for settlement of accounts for commodities, the operator can finish the receipt and payment processing as early as possible and quickly treat settlement of accounts for the commodities by causing the change dispenser 10 to operate independently. The operator can additionally input a type of the receipt and payment processing when no customer is waiting for settlement of accounts for commodities by causing the POS terminal 20 to display the icon. Therefore, it is possible to prevent occurrence of wrong calculation. In other words, it is possible to cause the change dispenser 10 to operate independently without causing wrong calculation. Consequently, it is possible to cause the change dispenser 10 to quickly perform the receipt and payment processing. A mechanism of the POS system having such characteristics is explained below.

As shown in FIG. 1, the change dispenser 10 includes a control unit 101, a storing unit 102, a communication unit 103, an input unit 104, and a receipt and payment device 105. The control unit 101 is a control device that controls the entire change dispenser 10. The storing unit 102 is a memory that stores various programs and data used for processing in the control unit 101. The communication unit 103 is a communication interface that controls communication performed between the change dispenser 10 and the POS terminal 20. The input unit 104 is an input unit for inputting various kinds of information. The input unit 104 can be a specific operation button or can be an input device with display unit that enables the operator to operate a plurality of operation buttons and input various kinds of information. The receipt and payment device 105 is a device that conveys a coin received from a coin input port to a coin storing unit and conveys a coin paid from the coin storing unit to a coin discharge port.

The control unit 101 includes an independent-operation-start-instruction receiving unit 11, a receipt-and-payment processing unit 12, and a receipt-and-payment-information transmitting unit 13.

The independent-operation-start-instruction receiving unit 11 receives an independent operation start instruction signal transmitted by the operator by operating the input unit 104 of the change dispenser 10. The independent operation means that the change dispenser is caused to operate independently without receiving a start instruction for receipt and payment processing from the POS terminal. The independent operation does not include operation of the change dispenser performed after the start instruction for receipt and payment processing is received from the POS terminal. It is determined, according to whether an independent operation signal is received, whether content of receipt and payment processing thereafter performed by the receipt-and-payment processing unit 12 is transmitted to the POS terminal 20. When the receipt and payment processing is executed after the independent operation signal is received, content of the receipt and payment processing is transmitted to the POS terminal 20 by the receipt-and-payment-information transmitting unit 13 described later. On the other hand, when the independent operation signal is not received and the receipt and payment processing is executed, content of the reception and payment processing is not transmitted to the POS terminal 20. Consequently, only when the receipt and payment processing is performed by the independent operation, content of the receipt and payment processing can be transmitted to the POS terminal 20. On the other hand, when the receipt and payment processing is performed in response to a receipt and payment execution instruction from the POS terminal 20, it is unnecessary to transmit content of the receipt and payment processing to the POS terminal 20. Therefore, unnecessary processing can be omitted.

The receipt-and-payment processing unit 12 executes various kinds of receipt and payment processing. As types of the receipt and payment processing, for example, there are processing for receiving a change reserve, processing for receiving sales of a vending machine, processing for receiving sales of gift certificates, and payment processing by an interim recovery. These types of receipt and payment processing are information that can be discriminated according to an execution instruction from the POS terminal 20. Therefore, during the independent operation, processing for receiving coins or processing for paying coins is simply performed according to an operation instruction of the operator. Content of the receipt and payment processing is stored in the storing unit 102 and managed by the control unit 101.

The receipt-and-payment-information transmitting unit 13 transmits, when a start instruction for the independent operation is received by the independent-operation-start-instruction receiving unit 11, receipt and payment information including content of receipt and payment processing, which is performed by the receipt-and-payment processing unit 12 after the reception of the start instruction, to the POS terminal 20 through the communication unit 103. The receipt and payment information includes an operator ID, receipt and payment classification, a receipt and payment amount, and receipt and payment time. In transmitting the receipt and payment information, the receipt-and-payment-information transmitting unit 13 judges whether communication through a line connecting the change dispenser 10 and the POS terminal 20 is possible. When it is judged that the communication is possible, the receipt-and-payment-information transmitting unit 13 transmits the receipt and payment information. On the other hand, when it is judged that the communication is impossible, the receipt-and-payment-information transmitting unit 13 repeats the judgment at every predetermined time until the communication through the line connecting the change dispenser 10 and the POS terminal 20 becomes possible. The communication through the line connecting the change dispenser 10 and the POS terminal 20 is judged as possible when, for example, a response signal responding to a connection confirmation signal transmitted by the change dispenser 10 is received from the POS terminal 20. On the other hand, the communication through the line connecting the change dispenser 10 and the POS terminal 20 is judged as impossible when, for example, a response signal responding to a connection confirmation signal transmitted by the change dispenser 10 cannot be received from the POS terminal 20. The communication through the line connecting the change dispenser 10 and the POS terminal 20 is impossible because, for example, a power supply is off due to failure of the POS terminal 20 or the line is disconnected.

As shown in FIG. 1, the POS terminal 20 includes a control unit 201, a storing unit 202, a communication unit 203, an input unit 204, a display with touch panel 205, and a printer 206. The control unit 201 is a control device that controls the entire POS terminal 20. The storing unit 202 is a memory that stores various programs and data used for processing in the control unit 201. The communication unit 203 is a communication interface that controls communication performed between the POS terminal 20 and the change dispenser 10. The input unit 104 is an input unit for inputting various kinds of information. As the input unit 104, for example, there are an operation key and a barcode scanner. The display with touch panel 205 is a display device including a touch panel. The printer 206 is an output device that prints and outputs various slips and the like.

The control unit 201 includes a receipt-and-payment-information receiving unit 21, an icon display/deleting unit 22, an alternation-processing prohibiting/releasing unit 23, an alternation-processing executing unit 24, an icon-execution judging unit 25, an input-screen display unit 26, a receipt-and-payment-information registering unit 27, and a receipt-and-payment-information printing unit 28.

The receipt-and-payment-information receiving unit 21 receives receipt and payment information, which is transmitted from the change dispenser 10, through the communication unit 203.

The icon display/deleting unit 22 causes, when the receipt and payment information is received by the receipt-and-payment-information receiving unit 21, the display with touch panel 205 to display an icon indicating that the receipt and payment information is received on a display screen thereof. An indicator displayed on the display screen is not limited to the icon and can be any indicator as long as the operator can recognize that the receipt and payment information is received. The icon display/deleting unit 22 deletes the icon from the display screen when types of receipt and payment corresponding to receipt and payment amounts included in all pieces of receipt and payment information generated by the independent operation of the change dispenser 10 are registered by the receipt-and-payment-information registering unit 27 described later. In other words, the icon display/deleting unit 22 deletes the icon from the display screen when there is no more receipt and payment information, a receipt and payment type of which is unregistered.

The alternation-processing prohibiting/releasing unit 23 prohibits, when the icon is displayed by the icon display/deleting unit 22, execution of operator alternation processing executed by the alternation-processing executing unit 24 described later. Specifically, the alternation-processing prohibiting/releasing unit 23 invalidates an execution instruction for alternation processing input through the input unit 204 when the operator causes the POS terminal 20 to execute the alternation processing. When the icon is deleted by the icon display/deleting unit 22, the alternation-processing prohibiting/releasing unit 23 releases the prohibition of execution of the operator alternation processing.

The alternation-processing executing unit 24 executes the operator alternation processing executed when the operator who operates the POS system changes.

The icon-execution judging unit 25 judges presence or absence of an execution instruction for the icon displayed by the icon display/deleting unit 22. In other words, the icon-execution judging unit 25 detects an execution instruction for the icon displayed by the icon display/deleting unit 22. As the execution instruction for the icon, for example, the operator touches the icon with a finger or the like or selects and clicks or double-clicks the icon with a pointer of a pointing device.

The input-screen display unit 26 displays, when the execution instruction for the icon is detected by the icon-execution judging unit 25, a receipt-and-payment-type input screen for enabling the operator to input a receipt and payment type for each piece of receipt and payment information received by the receipt-and-payment information receiving unit 21 on the display screen of the display with touch panel 205.

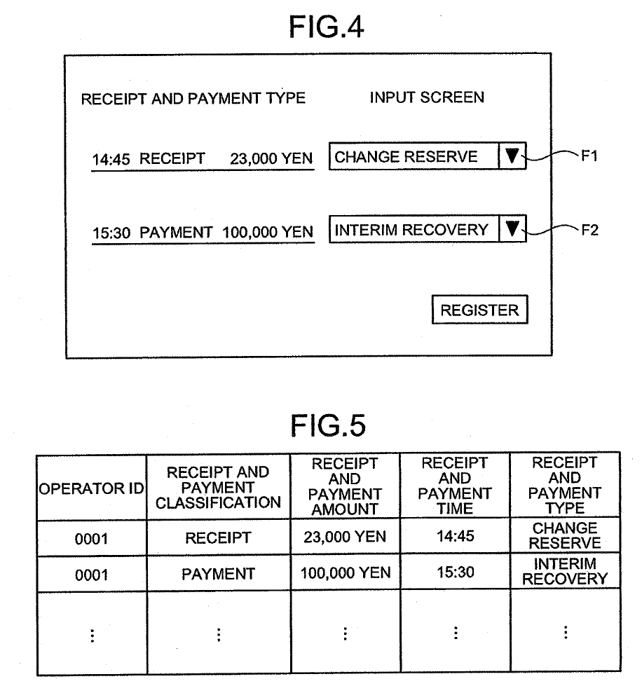

FIG. 4 is a diagram of an example of the screen structure of the receipt-and-payment-type input screen. As shown in the figure, two pieces of receipt and payment information are displayed on the receipt-and-payment-type input screen. For each of the pieces of receipt and payment information, input fields Fl and F2 for inputting types of receipt and payment are provided. “Change reserve” is input in the input field Fl for a receipt and payment type corresponding to receipt and payment information including receipt and payment time “14:45”, receipt and payment classification “receipt”, and a receipt and payment amount “23,000 yen”. “Interim recovery” is input in the input field F2 for a receipt and payment type corresponding to receipt and payment information including receipt and payment time “15:30”, receipt and payment classification “payment”, and a receipt and payment amount “100,000 yen”. The input fields F1 and F2 are fields in which data can be input in a pull-down system. It is possible to input a receipt and payment type by selecting a relevant type out of a plurality of prepared types. When a registration button provided in the receipt-and-payment-type input screen is touched, receipt and payment information including a receipt and payment type is stored in the memory by the receipt-and-payment-information registering unit 27 described later.

The receipt-and-payment-information registering unit 27 causes the storing unit 202 to store the receipt and payment type input from the receipt-and-payment-type input screen in association with the receipt and payment information received by the receipt-and-payment-information receiving unit 21.

FIG. 5 is a diagram of an example of the data structure of the receipt and payment information stored in the storing unit 202. As shown in the figure, the receipt and payment information includes an operator ID, receipt and payment classification, a receipt and payment amount, receipt and payment time, and a receipt and payment type. In the operator ID, the receipt and payment classification, the receipt and payment amount, and the receipt and payment time of the receipt and payment information, data of the operator ID, the receipt and payment classification, the receipt and payment amount, and the receipt and payment time included in the receipt and payment information received from the change dispenser 10 are stored, respectively. In the receipt and payment type of the receipt and payment information, data of the receipt and payment type input on the receipt-and-payment-type input screen is stored.

The receipt-and-payment-information printing unit 28 prints, using the receipt and payment information stored in the storing unit 202, a registration result of the receipt and payment information and various slips such as a receipt and a journal according to an operation instruction or the like of the operator and causes the printer 206 to output the registration result and the slips.

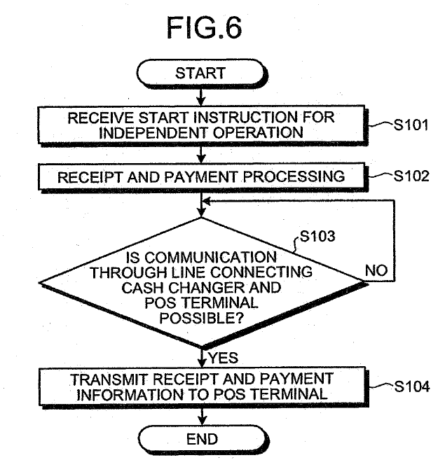

FIG. 6 is a flowchart of a processing procedure of the change dispenser 10 according to this embodiment. In this processing procedure, processing for receiving a change reserve in the change dispenser 10 is independently performed by the change dispenser 10.

First, the independent-operation-start-instruction receiving unit 11 of the change dispenser 10 receives a start instruction for independent operation transmitted according to an operation instruction of the operator (step Subsequently, the receipt-and-payment processing unit 12 performs, according to the operation instruction of the operator, receipt and payment processing for receiving bills or coins input from the input port as a change reserve (step S102).

When it is judged that communication through the line connecting the change dispenser 10 and the POS terminal 20 is possible (“YES” at step S103), the receipt-and-payment-information transmitting unit 13 transmits receipt and payment information including an amount of the change reserve received in the receipt and payment processing at step S102 to the POS terminal 20 (step S104). On the other hand, when it is judged that the communication through the line connecting the change dispenser 10 and the POS terminal 20 is impossible (“NO” at step S103), the receipt-and-payment-information transmitting unit 13 repeats the judgment at step S103 at every predetermined time until the communication through the line connecting the change dispenser 10 and the POS terminal 20 becomes possible.

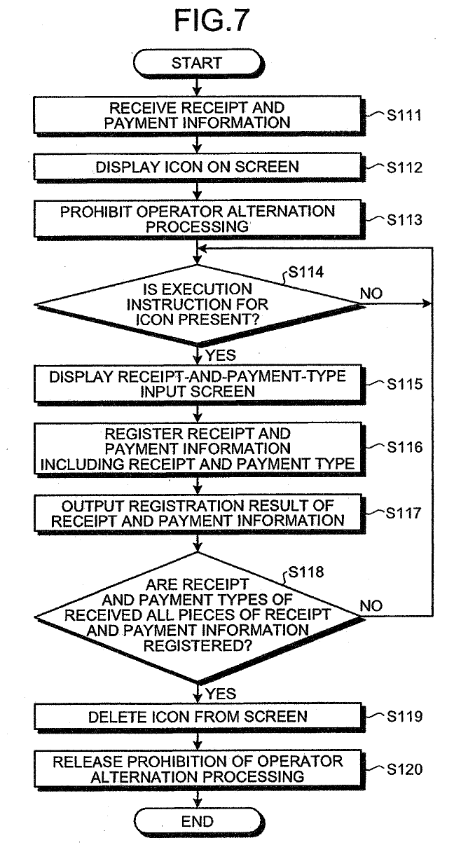

FIG. 7 is a flowchart of a processing procedure of the POS terminal 20 according to this embodiment. In the processing procedure, the POS terminal 20 receives the receipt and payment information transmitted from the change dispenser 10 at step S104 (FIG. 6).

First, the receipt-and-payment-information receiving unit 21 of the POS terminal 20 receives receipt and payment information transmitted from the change dispenser 10 (step S111).

Subsequently, the icon display/deleting unit 22 causes the display with touch panel 205 to display an icon indicating that the receipt and payment information is received on the display screen (step S112).

The alternation-processing prohibiting/releasing unit 23 prohibits execution of operator alternation processing by the alternation-processing executing unit 24 (step S113).

The icon-execution judging unit 25 judges presence or absence of an execution instruction for the icon displayed on the screen (step S114). When it is judged that the execution instruction for the icon is absent (“NO” at step S114), the input-screen display unit 26 is put on standby until the execution instruction is detected. On the other hand, when it is judged that the execution instruction for the icon is present, i.e., when the execution instruction for the icon is detected (“YES” at step S114), the input-screen display unit 26 displays the receipt-and-payment-type input screen on the display screen (step S115).

When the operator selects and inputs a receipt and payment type from the receipt-and-payment-type input screen and touches the registration button, the receipt-and-payment-information registering unit 27 registers the receipt and payment type input from the receipt-and-payment-type input screen in the storing unit 202 in association with the receipt and payment information received by the receipt-and-payment-information receiving unit 21 (step S116). The receipt and payment information including the receipt and payment type is registered in the storing unit 202.

The receipt-and-payment-information printing unit 28 prints a registration result of the receipt and payment information using the receipt and payment information stored in the storing unit 202 and causes the printer 206 to output the registration result (step S117).

The icon display/deleting unit 22 judges whether receipt and payment types corresponding to all pieces of receipt and payment information received by the receipt-and-payment-information receiving unit 21 are registered (step S118). When it is judged that the receipt and payment types corresponding to all the pieces of receipt and payment information are not registered (“NO” at step S118), the processing shifts to step S114.

On the other hand, when it is judged that the receipt and payment types corresponding to all the pieces of receipt and payment information are registered (“YES” at step S118), the icon display/deleting unit 22 deletes the icon from the display screen (step S119).

The alternation-processing prohibiting/releasing unit 23 releases the prohibition of execution of the operator alternation processing (step S120).

As described above, in the POS system 1 according to this embodiment, the change dispenser 10 can transmit, when a start instruction for independent operation according to an operation instruction of the operator is received, receipt and payment information including a receipt and payment amount received and paid after the start instruction to the POS terminal 20. On the other hand, the POS terminal 20 can cause, when the receipt and payment information transmitted from the change dispenser 10 is received, the display with touch panel 205 to display an icon indicating that the receipt and payment information is received on the display screen. The POS terminal 20 can cause, when an execution instruction for the icon is detected, the display with touch panel 205 to display the receipt-and-payment-type input screen on the display screen. The POS terminal 20 can cause the storing unit to register a receipt and payment type input from the receipt-and-payment-type input screen in association with the receipt and payment information including the receipt and payment amount and can delete the icon from the display screen.

Therefore, even when the operator causes the change dispenser 10 to operate independently and perform receipt and payment, receipt and payment information including an amount received and paid by the operation is surely notified to the POS terminal 20 and the POS terminal 20 receives the receipt and payment information. The POS terminal 20 can urge the operator to input a receipt and payment type corresponding to the receipt and payment information. The POS terminal 20 can cause the memory to register the receipt and payment type input by the operator in association with the receipt and payment information. When receipt and payment types of all pieces of receipt and payment information generated by the independent operation of the change dispenser 10 are input, the POS terminal 20 can finish urging the operator to input a receipt and payment type. Therefore, it is possible to cause the change dispenser 10 to quickly perform receipt and payment processing by causing the change dispenser 10 to operate independently without causing wrong calculation.

In the POS system 1 according to this embodiment, execution of alternation processing is prohibited when the icon is displayed on the display screen. The prohibition of execution of the alternation processing is released when the icon is deleted from the display screen. Therefore, unless the operator who causes the change dispenser 10 to operate independently inputs receipt and payment types of all pieces of receipt and payment information generated by the operation, the POS terminal 20 can prohibit the operator alternation processing. At a stage when the operator finishes inputting the receipt and payment types of all the pieces of receipt and payment information, the POS terminal 20 can resume the operator alternation processing. Consequently, the POS terminal 20 can surely manage all contents of receipt and payment. change dispenserchange dispenserchange dispenserchange dispenser According to the present invention, when the change dispenser receives an independent operation start instruction by an operation instruction of an operator, the change dispenser can transmit receipt and payment information including receipt and payment amounts of receipt and payment performed after the independent operation start instruction to the POS terminal. The POS terminal can cause, when the receipt and payment information transmitted from the change dispenser is received, the display device to display an indicator indicating that the receipt and payment information is received on the display screen. The POS terminal can cause, when an execution instruction corresponding to this indicator is detected, the display device to display an input screen for inputting a receipt and payment type for each of the receipt and payment amounts included in the receipt and payment information on the display screen, cause the storing unit to register the receipt and payment type input from the input screen in association with the receipt and payment information including the receipt and payment amounts, and cause the display screen to delete the indicator.

Consequently, it is possible to print receipt and payment information input by independent operation of the change dispenser on various slips such as a receipt and a journal and output the receipt and payment information together with a receipt and payment type input from the POS terminal.

According to the embodiment of the present invention, even when the operator causes the change dispenser to operate independently and perform receipt and payment, receipt and payment information including amounts received and paid by the operation is notified to the POS terminal and the POS terminal receives the receipt and payment information. The POS terminal can urge the operator to input a receipt and payment type corresponding to the receipt and payment information. The POS terminal can cause the storing unit to register the receipt and payment type input by the operator in association with the receipt and payment information. When types of receipt and payment of all pieces of receipt and payment information generated by the independent operation of the change dispenser are input, the POS terminal can finish urging the operator to input a receipt and payment type.

According to the embodiment of the present invention, unless the operator who causes the change dispenser to operate independently inputs types of receipt and payment of all pieces of receipt and payment information generated by the operation, operator alternation processing is prohibited. Therefore, the POS terminal can surely manage contents of all kinds of receipt and payment.

According to the embodiment of the present invention, at a stage when the operator who causes the change dispenser to operate independently finishes inputting types of receipt and payment of all pieces of receipt and payment information generated by the operation, the POS terminal can resume operator alternation processing.

According to the embodiment of the present invention, there is an effect that it is possible to cause the change dispenser to quickly perform receipt and payment processing by causing the change dispenser to operate independently without causing wrong calculation.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A POS system comprising:
a POS terminal; and
a change dispenser, wherein
the change dispenser includes
a start-instruction receiving unit that receives an independent operation start instruction for causing the change dispenser to start receipt and payment operation independently; and
a receipt-and-payment-information transmitting unit that transmits, when the independent operation start instruction is received by the start-instruction receiving unit, receipt and payment information including a receipt and payment amount received and paid after the independent operation start instruction to the POS terminal, and
the POS terminal includes
a receipt-and-payment-information receiving unit that receives the receipt and payment information transmitted from the change dispenser;
an indicator display unit that causes, when the receipt and payment information is received by the receipt-and-payment-information receiving unit, a display device to display an indicator indicating that the receipt and payment information is received on a display screen;
an execution-instruction detecting unit that detects an execution instruction for the indicator displayed by the indicator display unit;
an input-screen display unit that displays, when the execution instruction is detected by the execution-instruction detecting unit, an input screen for enabling an operator to input a receipt and payment type for each receipt and payment amount included in the receipt and payment information on the display screen;
a registering unit that registers the receipt and payment type input from the input screen, which is displayed by the input-screen display unit, in association with the receipt and payment information including the receipt and payment amount in a storing unit; and
an indicator deleting unit that deletes the indicator from the display screen when receipt and payment types corresponding to receipt and payment amounts included in all pieces of receipt and payment information received by the receipt-and-payment-information receiving unit are registered.

2. The POS system according to claim 1, wherein
the POS terminal further includes
an alternation-processing executing unit that executes operator alternation processing; and
a prohibiting unit that prohibits execution of the alternation processing when the indicator is displayed by the indicator displaying unit.

3. The POS system according to claim 2, wherein
the POS terminal further includes a releasing unit that releases the prohibition of execution of the alternation processing when the indicator is deleted by the indicator deleting unit.

4. The POS system according to claim 1, wherein
the POS terminal further includes an output unit that prints various slips using the receipt and payment type and the receipt and payment information registered by the registering unit to output the slips.

5. A method of controlling a POS system including a POS terminal and a change dispenser, the method comprising:
receiving an independent operation start instruction for causing the change dispenser to start receipt and payment operation independently in the change dispenser;
transmitting, when the independent operation start instruction is received in the change dispenser, receipt and payment information including a receipt and payment amount received and paid after the independent operation start instruction from the change dispenser to the POS terminal;
receiving the receipt and payment information transmitted from the change dispenser in the POS terminal;
displaying, when the receipt and payment information is received in the POS terminal, an indicator indicating that the receipt and payment information is received on a display screen of the POS terminal;
detecting an execution instruction for the indicator;
displaying, when the execution instruction is detected in the POS terminal, an input screen for enabling an operator to input a receipt and payment type for each receipt and payment amount included in the receipt and payment information on the display screen;
registering the receipt and payment type input from the input screen in association with the receipt and payment information including the receipt and payment amount in a storing unit; and
deleting the indicator from the display screen when receipt and payment types corresponding to receipt and payment amounts included in all pieces of receipt and payment information are registered.

6. The method according to claim 5, further comprising:
executing operator alternation processing; and
prohibiting execution of the alternation processing when the indicator is displayed on the display screen.

7. The method according to claim 6, further comprising releasing the prohibition of execution of the alternation processing when the indicator is deleted.

8. The method according to claim 5, further comprising printing various slips using the receipt and payment type and the receipt and payment information registered in the storing unit.
